(19) United States
(12) Patent Application Publication
(10) Pub. No.: US 2015/0220848 A1
(43) Pub. Date: Aug. 6, 2015

(54) Method and apparatus for determining a value of a movement-dependent variable

(71) Applicant: CONTINENTAL AUTOMOTIVE GMBH, Hanover (DE)

(72) Inventor: Ulf Bartholomäus, St. Georgen (DE)

(21) Appl. No.: 14/425,251

(22) PCT Filed: Sep. 2, 2013
(86) PCT No.: PCT/EP2013/068046

§ 371 Date: Mar. 2, 2015

(30) Foreign Application Priority Data
Sep. 3, 2012 (DE) 10 2012 215 601.1

(51) Int. Cl. G06N 7/00

(52) U.S. Cl. CPC G06N 7/005

(57) ABSTRACT

In a method for determining a value of a movement-dependent variable, a first measured value representing the movement-dependent variable is provided, and at least one second independent measured value representing the movement-dependent variable is provided. Each measured value is assigned a confidence value representative of a likelihood of the particular measured value being manipulated. The value of the movement-dependent variable is determined on the basis of the first measured value and at least the second measured value and the particular confidence value thereof.

### CROSS-REFERENCE TO RELATED APPLICATIONS

This is a U.S. national stage of application No. PCT/EP2013/068046, filed on 2 Sep. 2013, which claims priority to the German Application No. DE 10 2012 215 601.1 filed Sep. 2012, the content of both incorporated herein by reference.

### BACKGROUND OF THE INVENTION

1. Field of the Invention The invention relates to a method and an apparatus for determining a value of a movement-dependent variable.

2. Related Art Apparatuses, for example toll units or tachographs, require a position signal or a speed signal. This signal is often provided by a plurality of sensors. The signals from the sensors are compared with one another in order to possibly ensure a better position value or speed value.

DE 10 2007 059 785 A1 discloses an apparatus for checking the plausibility of a value of a movement-dependent variable, which apparatus has a rotary encoder for recording the value of the movement-dependent variable and an inertial sensor, the inertial sensor signal being compared with a digital signal from the rotary encoder.

WO 2009/043794 A1discloses a tachograph and a toll onboard unit both each comprising a data interface. The tachograph and the toll onboard unit are each designed, as transmitters of data, to determine a cryptographic check value on the basis of useful data, which are intended to be transmitted to the respective communication partner via the data interface, and to transmit the cryptographic check value. They are also designed, as receivers, to receive useful data and the associated cryptographic check value.

### SUMMARY OF THE INVENTION

An object on which the invention is based is to provide a method and a corresponding apparatus for determining a value of a movement-dependent variable.

One aspect of the invention is distinguished by a method and a corresponding apparatus for determining a value of a movement-dependent variable. A first measured value representing the movement-dependent variable is provided. At least one second independent measured value representing the movement-dependent variable is also provided. Each measured value is assigned a confidence value which is representative of a likelihood of the respective measured value being manipulated. The value of the movement-dependent variable is determined on the basis of the first measured value and at least the second measured value and their respective confidence value.

The value of the movement-dependent variable may be determined in a possibly more accurate and possibly more reliable manner by taking into account the respective confidence value when determining the value of the movement-dependent variable. The value of the movement-dependent variable may be, for example, a position value for a toll device and/or a speed value for a tachograph.

According to one advantageous refinement, each measured value is respectively assigned an accuracy value characteristic of the accuracy of the respective measured value. The value of the movement-dependent variable is determined on the basis of the respective accuracy value. The value of the movement-dependent variable may possibly be determined in an even more accurate manner by additionally also using the accuracy value of the measured value when determining the value of the movement-dependent variable.

According to another advantageous refinement, the measured values are weighted with the respective confidence value and/or the respective accuracy value. The value of the movement-dependent variable can be determined with little computing effort as a result of the weighting.

According to another advantageous refinement, the respective confidence value is determined on the basis of a self-diagnosis of the respective sensor, which provides the assigned measured value. The sensor can detect faults by virtue of the respective sensor carrying out a self-diagnosis. This then makes it possible to possibly adapt the confidence value on the basis of the self-diagnosis.

According to another advantageous refinement, the respective measured value for determining the value of the movement-dependent variable is taken into account or rejected on the basis of a comparison of the respective confidence value and/or the respective accuracy value with a threshold value. A higher degree of accuracy can therefore possibly be achieved when determining the value of the movement-dependent variable.

According to another advantageous refinement, a value of a second movement-dependent variable is determined on the basis of the value of the movement-dependent variable. A speed value can therefore be determined in addition to a position value or a position value can be determined in addition to a speed value, for example.

According to another advantageous refinement, at least one of the measured values is determined using a satellite-based measurement principle. The position can possibly be determined in a quick and relatively accurate manner as a result of measurement using a satellite-based measurement principle.

According to another advantageous refinement, at least one of the measured values is determined using dedicated short range communication (DSRC). Since many toll systems are implemented using DSRC, for example, it is possibly easy to determine the measured value using DSRC.

According to another advantageous refinement, the value of the movement-dependent variable is determined on the basis of Kalman filtering. The Kalman filtering makes it possible to quickly determine the value of the movement-dependent variable, for example.

According to another advantageous refinement, the measured values and/or the confidence values and/or the accuracy values and/or the value of the movement-dependent variable and/or the value of the second movement-dependent variable is/are permanently stored. The permanent storage makes it possible to subsequently read and possibly evaluate the data.

According to another advantageous refinement, the measured values and/or the confidence values and/or the accuracy values and/or the value of the movement-dependent variable and/or the value of the second movement-dependent variable is/are transmitted to a background system. The transmission makes it possible, for example, to evaluate the data in the background system and to possibly detect manipulation.

### BRIEF DESCRIPTION OF THE DRAWINGS

Exemplary embodiments of the invention are explained in more detail below using the schematic drawings, in which:

FIG. 1 shows an apparatus for determining a value of a movement-dependent variable; and

FIG. 2 shows a flowchart for determining a value of a movement-dependent variable.

Elements having the same design or function are denoted using the same reference symbols throughout the figures.

### DETAILED DESCRIPTION OF THE PRESENTLY PREFERRED EMBODIMENTS

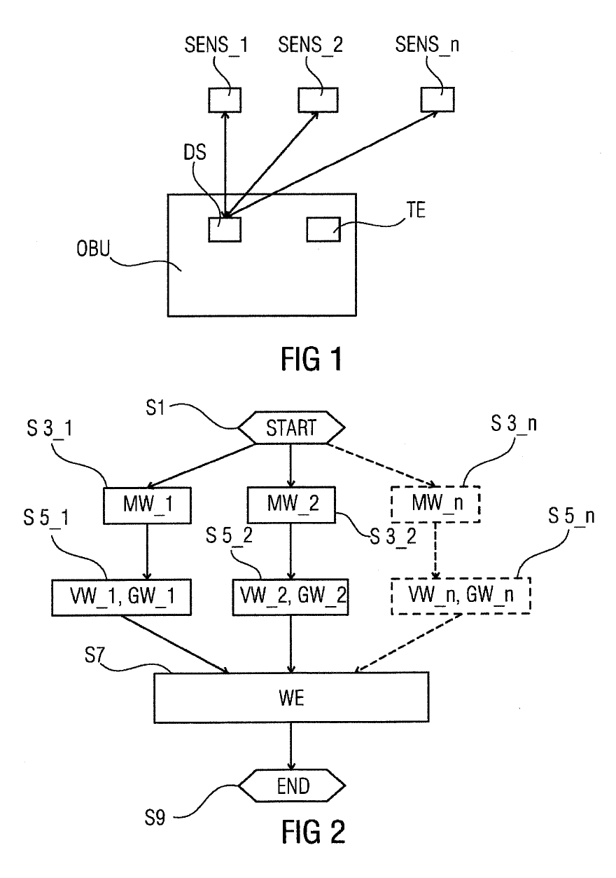

An apparatus OBU (FIG. 1) for determining a value of a movement-dependent variable WE is preferably arranged in a toll unit or a tachograph of a motor vehicle.

The apparatus OBU is protected by secure boot and/or other security technologies, for example. The apparatus OBU has at least one data interface DS, which is protected using trusted elements, for example. The data interface may receive measured values MW_1-MW_n, which are provided by a plurality of sensors SENS_1, SENS_2, SENS_n and/or by other measuring devices. The apparatus OBU may have the sensors SENS_1, SENS_2, SENS_n or a subset of the sensors SENS_1, SENS_2, SENS_n. The sensors SENS_1, SENS_2, SENS_n may also be arranged outside the apparatus OBU. They are designed to provide a measured value MW_n representing the movement-dependent variable, for example a position value or a speed value.

The measured value MW_n may be determined, for example, on the basis of a satellite-based measurement principle, for example GPS, Galileo or GLONASS. It may alternatively or additionally be determined from cell information from mobile radio networks such as GSM, UMTS or LTE, for example. Alternatively or additionally, it can be determined on the basis of dedicated short range communication (DSRC). Alternatively or additionally, it can be determined on the basis of cell information from WLAN or Bluetooth networks or other radio networks. Alternatively or additionally, it can be determined on the basis of a combination of past values of the movement-dependent variable and/or vehicle sensors, for example speed sensors, acceleration sensors, gyroscopes, rate-of-rotation sensors, compass sensors, and/or vehicle state information, for example ABS or ESP information, and/or other sensors known to a relevant person skilled in the art for such a purpose.

The apparatus OBU also has a tachograph unit TE. This makes it possible to implement both a toll unit and a tachograph unit in one apparatus.

As shown in FIG. 2, a program executed in the apparatus OBU is started in a step S1 in which variables can possibly be initialized.

In steps S3_1 to S3_n, measured values MW_1 to MW_n, each representing the movement-dependent variable, for example a position value or a speed value, is respectively provided by the sensors SENS_1 to SENS_n and/or by other measuring devices. The measured values MW_1 to MW_n may additionally each have a time stamp, for example.

In steps S5_1 to S5_n, confidence values VW_1 to VW_n are assigned to the respective measured values MW_1 to MW_n. Confidence values VW_1 to VW_n are representative of a likelihood of the respective measured values MW_1 to MW_n, respectively, being manipulated. A confidence value VW_n may be predefined for the respective measurement method of a measured value MW_n or may alternatively or additionally be determined in a variable manner. In addition, for example a respective accuracy value GW_n, which is characteristic of the accuracy of the respective measured value MW_n, is assigned to the measured value MW_n. The accuracy value GW_n may be predefined or may alternatively or additionally be determined in a variable manner.

In the case of a satellite-based measurement principle, the confidence value VW_n, for example, can be determined on the basis of a number of systems used, for example GPS and/or Galileo and/or GLONASS, since manipulation is possibly more difficult to carry out when more than one system is used and the likelihood of manipulation therefore decreases. The confidence value VW_n can alternatively or additionally be determined on the basis of use of signed services, for example the commercial service (CS) and/or the safe service (SoL) and/or the regulated service (PRS) in the case of Galileo. The confidence value VW_n can be alternatively or additionally determined, for example, on the basis of a self-diagnosis of the respective sensor SENS n or the respective measuring device. Signal interference, for example, can be detected on the basis of a self-diagnosis, for example by means of jamming detection; in this case, respective radio frequencies are monitored and a conclusion on interference is drawn on the basis of abnormalities in the radio frequencies.

The accuracy value GW_n can be determined, for example, on the basis of the number of systems used since the accuracy of the measured value possibly increases when more than one system is used.

If the measured value MW_n is determined on the basis of mobile radio information, for example using cell information relating to the mobile radio network, the confidence value VW_n, for example, can be determined, for example, on the basis of evaluation of a plurality of items of cell information at the same time, possibly taking into account the signal strength. The confidence value VW_n, for example, can alternatively or additionally be determined on the basis of use of encrypted or signed connections. The accuracy value GW_n can be determined, for example, on the basis of cell information such as the size of the radio cell. The accuracy value GW_n, for example, can be alternatively or additionally determined on the basis of use of additional positioning services of the mobile radio network, for example A-GPS and/or other geo-services.

If, for example, the measured value MW_n is determined on the basis of dedicated short range communication (DSRC), the respective confidence value VW_n can be determined on the basis of localization augmentation communication (LAC), for example. Alternatively or additionally, it can be determined on the basis of a check of beacon IDs.

If, for example, the measured value MW_n is determined on the basis of a radio network, for example a WLAN or Bluetooth network, the confidence respective value VW_n can be determined, for example, on the basis of a comparison of information relating to the reachable cells, for example the respective MAC address, with databases. Alternatively or additionally, the respective confidence value VW_n can be determined on the basis of use of additional position-relevant information relating to the radio networks.

Alternatively or additionally, the measured value MW_n, for example, can be determined on the basis of a combination of past values of the movement-dependent variable and/or vehicle sensors and/or vehicle state information. The respective confidence value VW_n can be determined, for example, on the basis of values from acceleration sensors, gyroscopes, compass sensors or other sensors since a likelihood of manipulation can be checked using these sensors. The respective accuracy value GW_n can also be determined on the basis of these sensors since the accuracy possibly increases using a plurality of sensors.

In a step S7, the value of the movement-dependent variable WE is determined on the basis of the measured values MW_1-MW_n provided and their respective confidence values VW_1 to VW_n and/or accuracy values GW_1 to GW_n. For example, the measured values MW_1-MW_n are weighted with the respective confidence value VW_n and/or the respective accuracy value GW_n. Alternatively or additionally, the value of the movement-dependent variable WE can be determined on the basis of Kalman filtering. Alternatively or additionally, it can be determined on the basis of dead reckoning or odometry. Alternatively or additionally, it can be determined using neural networks. A preceding value of the dependent variable or preceding values of the movement-dependent variable can additionally be concomitantly used to determine the value of the movement-dependent variable WE.

In a step S9, the program is ended and can be started again in step S1, if necessary.

After the value of the movement-dependent variable WE has been determined, a value of a second movement-dependent variable can also be determined on the basis of the value of the first movement-dependent variable WE. A speed value can be determined, for example, on the basis of a position value. This can be carried out by deriving the position value, for example. A tachograph can be implemented in addition to a toll unit, for example.

In addition, the measured values MW_1-MW_n and/or the confidence values VW_1-VW_n and/or the accuracy values GW_1-GW_n and/or the value of the movement-dependent variable WE and/or the value of the second movement-dependent variable can be permanently stored. For example, these data can be stored on a hard disk and can be subsequently read in order to create analyses. Manipulation can be detected, for example. In addition, it is possible to transmit these data to a background system. This can always be carried out, for example, or can be carried out only if manipulation is likely, for example, since one of the confidence values VW_1-VW_n exceeds or undershoots a predefined threshold value. This makes it possible to detect manipulation in the background system, for example.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-12. (canceled)

13. A method for determining a value of a movement-dependent variable (WE), comprising:
providing plural measured values (MW_1 to MW_n) representing the movement-dependent variable;
assigning each measured value (MW_1 to MW_n) respective confidence values (VW_1 to VW_n) each representative of a likelihood of the respective measured value being manipulated; and
determining the value of the movement-dependent variable (WE) on the basis of the plural measured values (MW_1 to MW_n) and their respective confidence values (VW_1 to VW_n).

14. The method as claimed in claim 13, wherein each of the plural measured values (MW_1 to MW_n) is respectively assigned accuracy values (GW_1 to GW_n) characteristic of the accuracy of the respective measured values (MW_1 to MW_n), and wherein the value of the movement-dependent variable (WE) is determined on the basis of the respective accuracy values (GW_1 to GW_n).

15. The method as claimed in claim 14, further comprising:
weighting the measured values (MW_1-MW_n) with the respective confidence values (VW_1 to VW_n) and/or the respective accuracy values (GW_1 to GW_n).

16. The method as claimed in claim 13, wherein the respective confidence values (VW_1 to VW_n) is determined on the basis of a self-diagnosis of a respective sensor that provides the assigned measured values (MW_1-MW_n).

17. The method as claimed in claim 14, the respective measured values (MW_1-MW_n) for determining the value of the movement-dependent variable (WE) being either taken into account or rejected on the basis of a comparison of the respective confidence values (VW_1 to VW_n) and/or accuracy values (GW_1 to GW_n) with a threshold value.

18. The method as claimed in claim 14, wherein a value of a second movement-dependent variable is determined on the basis of the value of the movement-dependent variable (WE).

19. The method as claimed in claim 13, wherein at least one of the measured values (MW_1 to MW_n) is determined using satellite-based measurement.

20. The method as claimed in claim 13, wherein at least one of the measured values (MW_1 to MW_n) is determined using dedicated short range communication.

21. The method as claimed in claim 13, wherein the value of the movement-dependent variable (WE) is determined on the basis of Kalman filtering.

22. The method as claimed in claim 18, wherein the measured values (MW_1-MW_n) and/or the confidence values (VW_1-VW_n) and/or the accuracy values (GW_1-GW_n) and/or the value of the movement-dependent variable (WE) and/or the value of the second movement-dependent variable is/are permanently stored.

23. The method as claimed in claim 18, wherein the measured values (MW_1-MW_n) and/or the confidence values (VW_1-VW_n) and/or the accuracy values (GW_1-GW_n) and/or the value of the movement-dependent variable (WE) and/or the value of the second movement-dependent variable is/are transmitted to a background system.

24. An apparatus for determining a value of a movement-dependent variable (WE) configured to carry out a method as claimed in claim 13.
